(19) United States
(12) Patent Application Publication
(10) Pub. No.: US 2016/0255024 A1
(43) Pub. Date: Sep. 1, 2016

(54) SYSTEMS AND METHODS FOR MANAGING PRESENTATION OF MESSAGE CONTENT AT USER COMMUNICATION TERMINALS

(71) Applicant: VONAGE NETWORK LLC, Holmdel, NJ (US)

(72) Inventors: Royee Tichauer, Haifa (IL); Iliya Barenboim, Ramata Gan (IL); Lihi Gendelis, Tel Aviv-Yafo (IL); Raz Liberman, Tel Aviv (IL)

(21) Appl. No.: 14/633,594

(22) Filed: Feb. 27, 2015

(51) Int. Cl. H04L 12/58

(52) U.S. Cl. CPC H04L 51/08; H04L 51/36

(57) ABSTRACT

A method for managing the presentation of enhanced message content includes receiving a message including an identification of one or more recipients and message content, determining, by execution of instructions by a processor, that the received message includes a tag for invoking at least one of enhanced presentation of the message content or a notification, and generating at least one of a reformatted message, wherein the reformatted message includes the message content reorganized according to the tag, or a notification, formatted according to the tag, for alerting at least one of the one or more recipient that the message relates to a particular topic or has an enhanced priority.

### BACKGROUND

1. Field

Embodiments consistent with the present invention generally relate to methods and apparatus for presenting message content generated, exchanged and/or received by or at a user communication terminal.

2. Description of the Related Art

Over the course of a day, the user of a display-equipped communications terminal such, for example, as a mobile phone, smartphone, tablet computer, personal digital assistant, or a laptop, notebook, or desktop computer (each, a “user communication terminal”) may create, forward and/or receive a large number of text, chat, and/or e-mail messages. As the volume of messages received by a recipient increases, a common reaction is for that recipient to quickly (and often hastily) form an opinion as to the relevance of that message to him or her. This opinion may be influenced strongly by the identity of the sender, by the subject matter to which the message pertains, or even by the association of the message with a pre-defined group of recipients. However, this response can lead a recipient to defer review of a message relating to a critical deadline, appointment, meeting, or other information relayed to him or her by a friend, colleague or supervisor. A less risky user reaction to high inbound message volumes is for the recipient to quickly scan only the first few lines of a message for high priority content and, if such content is not present in this portion of the message, the recipient defers his or her response to it. Such a reaction is especially common when the recipient is using a communication terminal having a relatively small display size and/or a cumbersome user interface.

Accordingly, there is a need for improved methods and systems for managing the presentation of message content to those using a communication terminal to access one or more messages, and for facilitating the creation and/or forwarding of such messages to enable such presentation.

### SUMMARY

The inventors herein propose systems and methods operative to selectively designate, for enhanced presentation of content and/or notifications to one or more recipients, messages exchanged between users of user communication terminals and, alternatively or in addition, to present messaging content and/or notifications to the user of such communication terminals based on the presence or absence of such designation.

In some embodiments, the method includes receiving a message including an identification of one or more recipients and message content, determining, by execution of instructions by a processor, that the received message includes a tag for invoking at least one of enhanced presentation of the message content or a notification, and generating at least one of a reformatted message, wherein the reformatted message includes the message content reorganized according to the tag, or a notification, formatted according to the tag, for alerting at least one of the one or more recipient that the message relates to a particular topic or has an enhanced priority.

In some embodiments, a computer implemented method comprises, at a first communication terminal, receiving user input corresponding to an identification of one or more recipients and to message content intended for delivery to the one or more recipients. The method further comprises initiating display of the message content according to a user interface, determining, by execution of instructions by a processor of the first communication terminal, that the received user input includes one of a tag or gesture for invoking at least one of enhanced presentation of the message content or a notification to the one or more recipients at respective recipient communication terminals and generating at least one of a preview message, wherein the received message content is formatted for presentation based on the tag, or a preview notification, wherein the preview notification is formatted based on by the tag and for alerting at least one of the one or more intended recipients that the message relates to a particular topic or has a higher expected priority for the at least one recipient than for other recipients. In some embodiments, the method further includes initiating display of the preview message and/or preview notification at the first communication terminal.

In some embodiments, a system for managing presentation of enhanced message content at a recipient user communication terminal, comprising a display, a processor, and a memory containing instructions executable by the processor to receive a message including an identification of one or more recipients and message content intended for delivery to at least one of the one or more recipients, to determine by execution of instructions by the processor, that the received message includes a tag for invoking at least one of enhanced presentation of the message content or a notification to the one or more recipients at respective recipient communication terminals. If the received message includes a tag, in some embodiments the instructions stored in memory are further executable by the processor to generate at least one of a reformatted message, wherein the reformatted message includes the message content reorganized according to or based on the tag, or a notification, formatted according to or based on the tag, for alerting at least one of the one or more intended recipients that the message relates to a particular topic or has a higher priority than other messages received from an author of the received message.

Other and further embodiments of the present invention are described below.

### BRIEF DESCRIPTION OF THE DRAWINGS

So that the manner in which the above recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a block diagram depicting a communication system configured to aid message authors in the selective creation of messages which facilitate the enhanced presentation of message content and/or notifications to message recipients, and/or configured to enhance the experience of one or more users interacting with such messages, at corresponding communication terminals, according to one or more network centric embodiments;

FIG. 1B depicts a block diagram of a communication system configured to aid message authors in the selective creation of messages which facilitate the enhanced presentation of message content and/or notifications to message recipients, and/or configured to enhance the experience of one or more users interacting with such messages at corresponding communication terminals, according to one or more communication terminal (e.g. “endpoint”) centric embodiments;

FIG. 1C is a block diagram depicting, in greater detail, the interaction between functional components according to some embodiments exemplified by FIG. 1A;

FIG. 2 is a flow diagram of a method for managing the creation of tagged message content, at a first user communication terminal, to facilitate enhanced presentation of the message content and/or an accompanying notification, according to one or more embodiments of the invention;

FIG. 3 is a flow diagram of a method for creating messages, having one or more embedded tags to facilitate the enhanced processing of the messages by a recipient communication terminal, as, for example, a sub-process of the method of FIG. 2, according to one or more embodiments of the invention;

FIG. 4 is a flow diagram of a method for creating messages, having one or more embedded tags to facilitate the enhanced processing of the messages by a recipient communication terminal, as, for example, a sub-process of the method of FIG. 2, according to one or more embodiments of the invention;

FIG. 5 is a flow diagram of a method for previewing messages having one or more embedded tags, during a message creating process, to facilitate the enhanced processing of the messages by a recipient communication terminal, as, for example, a sub-process of the method of FIG. 2, according to one or more embodiments of the invention;

FIG. 6 is a flow diagram of a method for processing and/or presenting received messages, having one or more embedded tags, to facilitate the enhanced processing of the messages by a recipient communication terminal, according to one or more embodiments of the invention;

FIG. 7A is a message flow diagram depicting the development, flow and processing of messages between a first message exchange participant (e.g., a sender) and a second message exchange participant (e.g., a recipient), at least some of the messages including tags for enhancing the presentation of notifications to a message recipient in accordance with one or more embodiments;

FIG. 7B is message flow diagram depicting the development, flow and processing of messages between a first message exchange participant (e.g., a sender) and a second message exchange participant (e.g., a recipient), at least some of the messages including tags for enhancing the presentation of message content to a message recipient in accordance with one or more embodiments;

FIG. 8A depicts a communication terminal operated by a user to visually present a sequence of messages forming at least part of a first message exchange between two or more participants and to create, edit or forward a message containing one or more tags for enhancing the experience of the recipient(s), according to one or more embodiments of the invention;

FIG. 8B depicts the communication terminal of FIG. 8A following the processing of received message content and corresponding tag(s) to generate a reformatted presentation of the message content based on a single included tag, according to one or more embodiments of the invention;

FIG. 8C depicts the communication terminal of FIGS. 8A and 8B operated by a user to visually present a sequence of messages forming at least part of a second message exchange between two or more participants and to create, edit or forward a message containing a plurality of tags for enhancing the user experience of a recipient, according to one or more embodiments of the invention;

FIG. 8D depicts a recipient communication terminal participating in the exchange presented on the display shown in FIG. 8C and following the processing of received message content and corresponding tags to generate a reformatted presentation of the message content based on a plurality of included tags, according to one or more embodiments of the invention; and

FIG. 9 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention include a system and method for generating and/or processing messages, which include one or more tags, to facilitate the enhanced display of notifications and/or message content to one or more message recipients. Some exemplary embodiments consistent with the claimed invention improve upon standard message exchange and group chat client application functionality by enabling a message author to embed one or more tags in the message so that, at a recipient's terminal, the accompanying message content is formatted according to a template associated with or specified by the tag. Alternatively, or in addition, the message author may embed a tag specifying a particular recipient so that an enhanced notification is generated and/or displayed at a specified message recipient's terminal.

The inclusion of a tag in a message, according to some embodiments, serves to invoke special presentation formatting at the recipient terminal. In an embodiment, tagged message content is formatted in such a way that the recipient is presented with menu options and is able to quickly respond without having to type any text, thereby leading to both an enhanced user experience and, potentially, an earlier response. In another embodiment, the user is alerted to the presence of a tagged message according to preferences or user settings that allow the recipient to recognize the relevance and/or importance of the message as compared to untagged messages.

Various embodiments of systems and methods for administering and presenting message content and notifications according to one or more accompanying tags are provided below. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

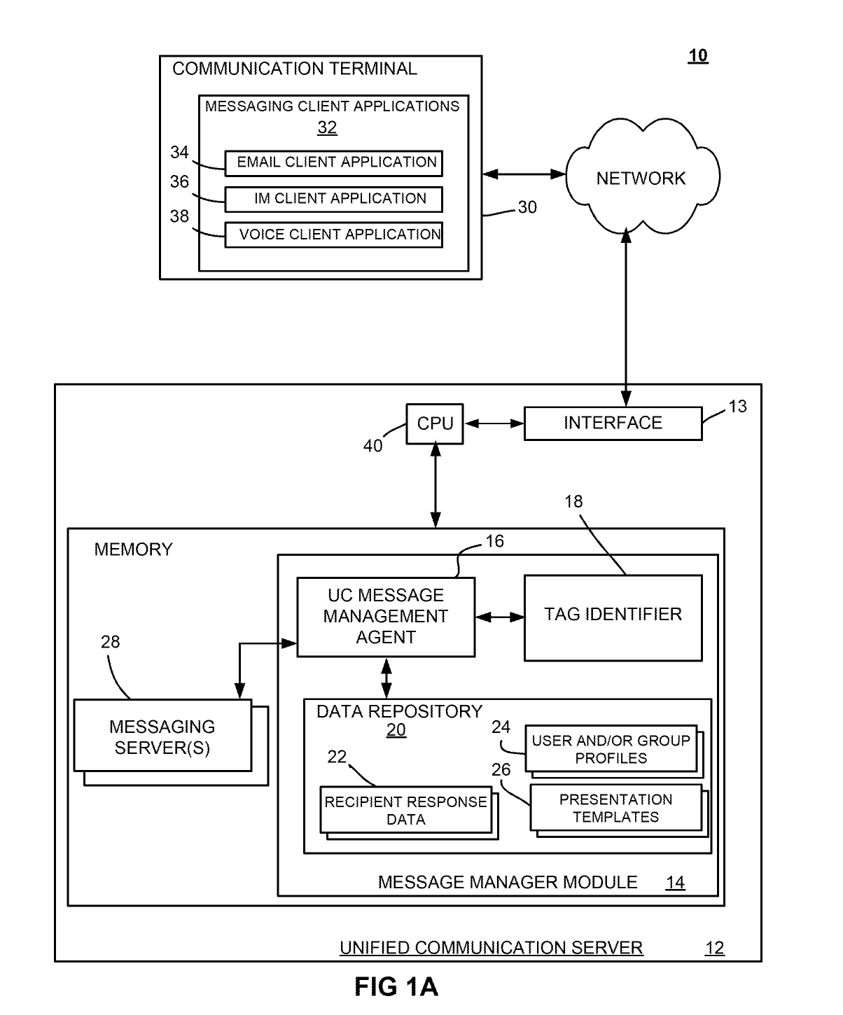

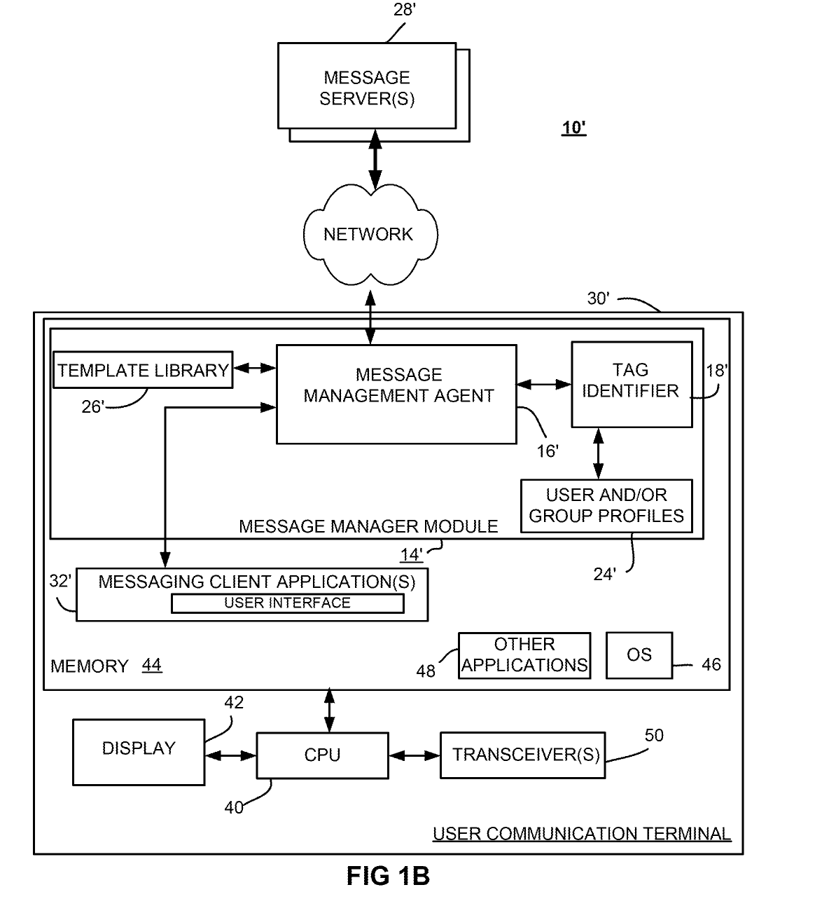

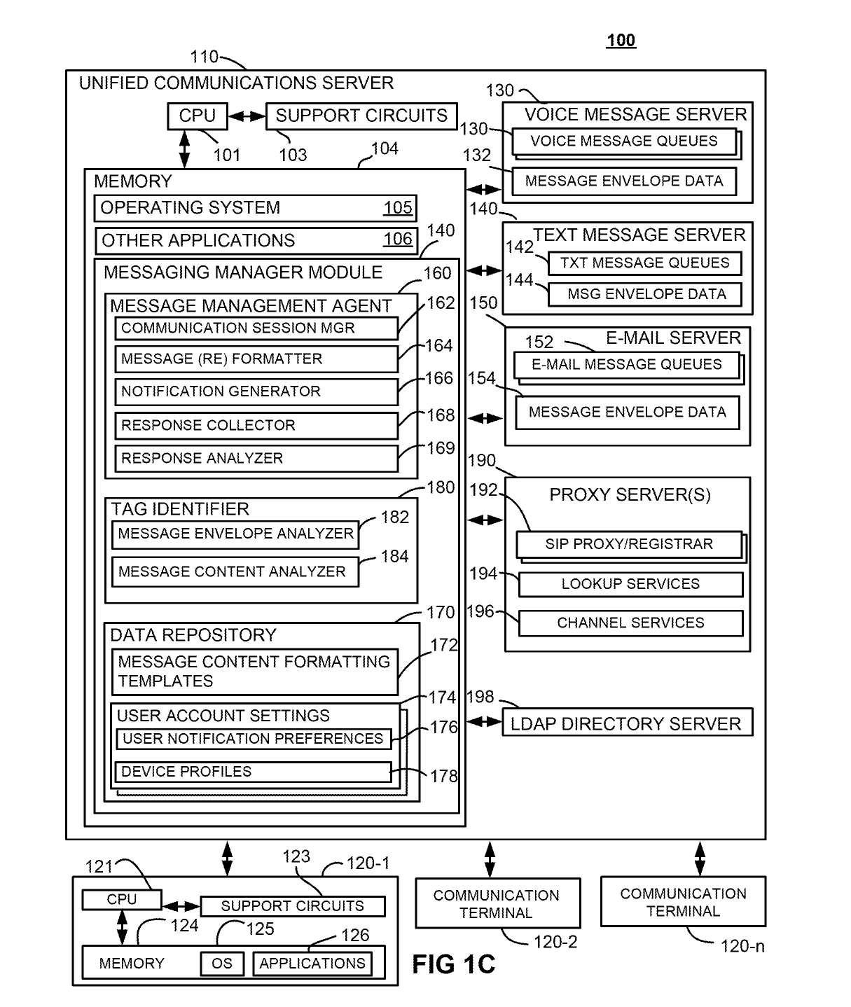

FIG. 1A depicts a block diagram of a communication system 10 configured to aid message authors and recipients in the creation and/or presentation of enhanced messages and notifications, through the inclusion of one or more tags in those messages, according to one or more network centric embodiments. According to some embodiments, system 10 includes a unified communication server 12 having a message manager module 14. Message manager module 14 includes a unified communication (UC) message management agent 16 configured to examine and process messages which, in addition to message content intended for one or more recipients, may also contain one or more tags. In some situations, a tag within the body of a message may identify a specific recipient—from among a group of intended recipients—for whom the associated message content is expected by the author to have particular relevance. In other cases, a tag may be incorporated into a message in such a way that it identifies a specific topic or subject in which one or more recipients has already expressed interest via a formal or informal “subscription” process. In still other situations, a tag incorporated within a message triggers the invocation, at a communication terminal of one or more recipients, of a particular presentation format. To facilitate the processing of tags according to each of the aforementioned scenarios, some embodiments of message manager module 14 include a tag identifier 18 to identify the tag(s) present in a message.

In accordance with some embodiments of the present disclosure, the presence of a tag in a message triggers the message management agent 16 to select an appropriate presentation template 26 from data repository 20. For example, a tag “@menu” followed by a parenthetically presented list of options as in (“option 1, option 2, option 3”) within the body of a message containing the text “Where would you like to eat, tonight?” might trigger message management agent 16 to select and retrieve a menu template. From this template, message management agent 16 generates, for display on a recipient's terminal, the specified query followed by a series of restaurant choices. A recipient of such a reformatted message need only click or press a radio button adjacent to the correct movie choice rather than respond to the author by telephone or text message.

To ensure that the communication terminal of the user(s) being presented with the choices are able to properly access and/or respond to a query reformatted in the this manner, data repository 20 further includes user and/or group profiles 24. The profile(s) include, in some embodiments, specific user preferences and/or an identification of device capabilities of the communication terminals employed by the users, as communication terminal 30 shown in FIG. 1A. By way of example, a first intended recipient of a reformatted message may prefer not to receive re-formatted message content at all, electing instead to simply see a tagged message in its original format. Another intended recipient of the very same message may prefer to have the reformatting done for display on his or her communication terminal, while yet another may prefer that the choices be presented via voice mail message or via an interactive voice response unit (IVR). In the latter regard, message management agent 16 may be configured to perform text to speech and to try contacting the recipient by phone to collect the response(s) before addressing a reformatted message to the recipient's communication terminal for display.

In some embodiments, the responses to a reformatted message received from one or more communication terminal users are collected by message management agent 16 and stored as recipient response data 22 within data repository 20. Such storage enables, for example, all participants of a messaging or “chat” group to see the responses from the others. Here again, agent 16 may refer to the user and/or group profiles to determine the manner in which the response(s) should be disseminated to the original author and or any other participants having access to the message. In a voting scenario, where the menu choices exemplified above where intended, by the author, to be seen by multiple invitees, message management agent 16 may select and retrieve a “results” template for presenting the responses of all responding members of a group to one or more queries. Posting or distribution of a message communicating the “results” may be deferred until either a specified deadline specified by the author is reached or until all intended respondents have actually submitted their answer(s).

In an embodiment, system 10 further includes one or more messaging servers 28 including, by way of illustrative example, an email server, a text messaging and/or chat server, a short messaging service (SMS) server, and a voice mail server and corresponding speech to text processor. To make use of some or all of the services supported by messaging server(s) 28, each communication terminal 32 includes messaging client applications 32 which may include an e-mail application 34, an instant messaging (IM) client application 36, and a voice client application 38.

In some embodiments, the unified communication server 12 comprises one or more network interfaces 13 comprising, for example, transmission and receiving devices as transceivers compliant with corresponding transport or transmission protocol(s) such as IEEE 802.11, IEEE 802.13, BLUETOOTH, and/or cellular transmission protocols such as Code Division Multiple Access (CDMA), Time Division Multiple Access (TDMA) and/or Global System for Mobile communications (GSM). In embodiments, a communication session module (not shown) is configured, by execution of instructions by a processor, to perform functions of a SIP (Session Initiation Protocol) Proxy/Registrar, message exchange service, Group Chat Server lookup service, and/or Group Chat Server channel service. In addition or alternatively, the communication session module in some embodiments of system 10 is configured, by execution of instructions by a processor, to forward a telephone call or to send an SMS, MMS or IM chat message to one or more intended recipients via a communications network. Message manager module 14 and messaging servers 28 are, in some embodiments, resident in memory 44 as instructions executable by a central processor 40.

FIG. 1B is a block diagram depicting an embodiment of a communication system 10′ configured to aid message authors and recipients in the creation and/or presentation of enhanced messages and notifications, through the inclusion of one or more tags in those messages, according to one or more user communication terminal centric embodiments. The arrangement of and interrelationships between the various functional components of the embodiment of FIG. 1B are very similar to those of the embodiment of FIG. 1A. A principal difference between the respective embodiments is that in the former case, contemporaneous monitoring and evaluation of messages and responses for processing, based on the presence of tags, are performed locally by a message manager module 14′ program executed locally on the communication terminals rather than at a central server. In the illustrative embodiment of FIG. 1A, on the other hand, at least some of the message manager module's message formatting and/or response data collection functions are performed remotely at a central server.

In an embodiment, system 10′ includes one or more communication terminals such as terminal 30′ each having a central processing unit (CPU) 40, support circuits (not shown), a memory 44′ containing an operating system 46 and applications 48 executable by CPU 40, and an associated display 42. Applications residing in memory 44′ include message manager module 14′, which contains a message management agent 16′ communicatively coupled by a network connection established via transceivers 50 to one or more remote messaging server(s) 28′. Also communicatively coupled to the message management agent 16′ are tag identifier 18′, user and/or group profiles 24′, presentation template library 26, and one or more messaging client application(s) 32′ as described previously.

FIG. 1C is a block diagram depicting, in greater detail, the interaction between functional components in a communication system 100 comprising a unified communications server 110. In some embodiments, the unified communications server 110 includes a voice messaging and/or call server 130, text messaging manager module/server 140, e-mail server 150, proxy server(s) 190, and a Lightweight Directory Access Protocol (LDAP) directory server 198. The various components of system 100, including unified communication server 110, and communication terminals 120-1 to 120-n, are connected by one or more network links. Some of the links are established by a network, such as a Wide Area Network (WAN) or Metropolitan Area Network (MAN), which includes a communication system that connects computers (or devices) by wire, cable, fiber optic and/or wireless link facilitated by various types of well-known network elements, such as hubs, switches, routers, and the like. The network interconnecting some components may also be part of a Local Area Network (LAN) using various communications infrastructure, such as Ethernet, Wi-Fi, a personal area network (PAN), a wireless PAN, Bluetooth, Near field communication, and the like.

The various servers 130, 140, 150, 190, and 198 are each a computing device, or may be the same computing device as, for example, a desktop computer, laptop, tablet computer, and the like, or they may be cloud based servers e.g., a blade server, virtual machine, and the like. For each provisioned voice mail user or subscriber, voice mail server 130 maintains a voice mail message queue 132 and message envelope date 134 indicating a date and time when a voice mail message was left for a provisioned user, an identification of the caller or caller's extension (if available), whether and when a voice mail message was forwarded to another extension (a voice message forwarded to another party qualifying as a “response” according to one or more embodiments), and an indication of a date and time when the user first accessed the voice mail. In some embodiments, server 130 further includes a speech-to-text interface (not shown) operative to convert voice messages into email messages.

For each provisioned text messaging, SMS or MMS messaging client, which may accommodate one-to-one, one-to-many, and multiple participant “group” chat message exchanges, messaging manager module/server 140 maintains message queue 142 and message envelope information 144 identifying a message originator's network address, a recipient's network address, the date and time of delivery to each recipient and/or to a group chat “room”, and user account settings including rules and preferences defined by the user.

For each provisioned email user or subscriber, email server 150 maintains an email message queue 152 and message envelope information 154 identifying the sender's email address, each recipient's email address, the date and time of delivery to an email inbox, and user account settings including rules and preferences defined by the user.

According to one or more embodiments, Proxy server(s) 190 and LDAP directory server 198 provides sender and recipient (and/or group) directory lookups as needed to support the exchange of messages between communication terminal endpoints. In some embodiments, proxy server 190 is a SIP proxy server comprising a SIP/Proxy registrar 192, lookup services 194, and channel services 196 which collectively manage processes for authenticating users and managing the exchange of messages between endpoint communication terminals

According to some embodiments, unified communication server 110 includes a messaging manager module 140 comprising a set of instructions residing in memory 104 and executable by a Central Processing Unit (CPU) 101. The CPU 101 may include one or more commercially available microprocessors or microcontrollers that facilitate data processing and storage. Various support circuits 103 facilitate the operation of the CPU 101 and include one or more clock circuits, power supplies, cache, input/output circuits, and the like. The memory 104 includes at least one of Read Only Memory (ROM), Random Access Memory (RAM), disk drive storage, optical storage, removable storage and/or the like.

In addition to message manager module 140, memory 104 includes an operating system 105, and a plurality of applications which may optionally include a speech-to-text converter (not shown). The operating system (OS) 105 generally manages various computer resources (e.g., network resources, file processors, and/or the like). The operating system 105 is configured to execute operations on one or more hardware and/or software modules, such as Network Interface Cards (NICs), hard disks, virtualization layers, firewalls and/or the like. Examples of the operating system 120 may include, but are not limited to, LINUX, MAC OSX, BSD, UNIX, MICROSOFT WINDOWS, and the like.

In some embodiments, server 110 interacts with a plurality of communication terminals 120-1 to 120-n via a communication network. Each of the communication terminals, as 120-1 also includes one or more processors as CPU 121, support circuits 123, and a memory 124 containing an operating system 125 and applications 126. Also associated with the communication terminal 120-1 in some embodiments is a display device (not shown) which may comprise a touch screen able to accept input from a user's finger or input from a stylus. In some embodiments, applications 126 include a communication session module configured, by execution of instructions by CPU 121, to set up a telephone call or send an SMS, IM chat, or MMS message to an intended recipient via the communication network.

Message manager module 140 includes a message management agent 160 comprising a communication session manager 162 for directing the exchange of messages between the server 110 and the communication terminals 120-1 to 120-n, and a message formatter/re-formatter 164 for modifying the arrangement of message content present in a message in response, for example, to the detection of a tag or other identifier in a message that signifies the applicability of a reformatting operation specific to the detected tag. As previously described, the formatting applied to a particular message in accordance with a tag may be based upon the tag(s) specified by a user and, alternatively or in addition, upon the preferences of the intended recipient(s) and/or the rules or policies applicable to a particular group.

In this latter regard, message manager agent 160 of message manager module 140 is configured, according to some embodiments, to process a message as if a tag were included by the message author, even if the tag were actually omitted by its creator. For example, in embodiments where the recipient's terminal is configured to identify the presence of a tag and generate a notification so as to call the recipient's specific attention to that subset of received messages which incorporate the tag, the tag may be inserted, automatically, by message re-formatter 164 in response to the recognition of a keyword identified in the recipient's profile.

For example, if the user of a communication terminal is collaborating with a number of colleagues on a particular project, the user and/or any of the other collaborating participants may provide a list of key words and/or phrases associated with that project. Applying automatic keyword recognition to the content of a received message, message management agent 160 might determine that the message contains a keyword corresponding to a particular project or a particular subset of the recipients for which that keyword has specific relevance. Responsive to such determination, embodiments of message management agent 160 are configured to insert one or more tags identifying, respectively, a particular subject (e.g., the project), a particular topic (e.g., a specific aspect of the project such as a problem being experienced), and/or a specific one of the participants or specific ones of the participants (e.g., those who have either self-identified as being especially interested in the subject or topic, or those who have been assigned that status by an administrator or other party).

By way of still further example, a particular group of messaging client users sharing their collective responses and queries as part of a unified “chat” exchange may have a number of topics discussed as separate threads of a single message flow. These topics may be established a priori for the group such that individual participants may “subscribe” to specific topic threads, and those messages tagged—so as to demonstrate a relationship to a subscribed topic—would be subject to a higher priority notification at the recipient terminal. Conversely, those not tagged might either be filtered out entirely, or agent 160 would generate a lower priority notification. As before, the mere fact that a list of topics may not have been established a priori does not prevent enhanced processing in accordance with embodiments consistent with the present disclosure. In his or her profile, a user may specify specific keywords the presence of which are sufficient to identify a message as relating to a self-selected topic to which the user would like to “subscribe”. As before, agent 160 might insert a tag into a message before routing it to the recipients, following a determination that a particular key word or phrase is present in the message. Alternatively, the creator of the message may insert the appropriate tag(s) when composing a message or responding to an early one.

Message manager module 160 agent further includes a notification generator or manager 166 for generating prompts and alerts to be sent or presented to the users of terminals 120-1 to 120-n, based on the presence or (absence, as the case may be) of a tag applicable to a particular user or user(s) and their corresponding notification preferences. Finally, message management agent 160 includes a response collector 168 and a response analyzer 169. In embodiments, for example, where re-formatter 164 arranges the content of a message based on the identification of a tag such that the user is presented with a menu or other form requiring a response in the form of a selection made by gesture or other input, the response collector 168 receives and stores the response for subsequent analysis by response analyzer 169. In some embodiments, analysis is performed only after all designated message addressees, recipients, or group participants have responded, or after the expiration of a time period set by the original message author.

To facilitate the reformatting of messages based on the presence of one or more tags, message manager module 140 further includes a data repository 170 which contains, in some embodiments, one or more message content formatting templates 172, and user account settings 174. The user account settings 174 may include user notification preferences 176 specifying, for example, the form and/or manner of notifying a recipient when a tagged message is received. The form of the notification may be the same for all tagged messages but different from the notification applicable to untagged messages. By way of example, arrival or availability of a message characterized by a topic, subject or recipient tag might be audibly announced, or by invocation of a device's “vibrate mode”, if such capability is present, while the arrival other messages are not announced in this manner, or are announced in an audibly distinguishable manner.

Alternatively, or in addition, account settings 174 may provide that certain messages are visually distinguishable in a list presented to a recipient, in accordance with some embodiments, based on the presence (or absence) of a tag. For example, a display device such as mobile terminal, tablet, notebook or desktop computer, or even a desktop phone with a suitable display, might present the user with a list of messages in which tagged messages are color coded to distinguish them from untagged messages. In some embodiments, user account settings 174 may associate a different color and/or audible alert with a particular tag. Device profiles 178 contain information relating to communication terminals known to be associated with a user. The information, which may relate to the size and resolution of a display, the type(s) of user input accommodated by the device (e.g., touchscreen, mouse, soft and/or assigned device buttons, speech recognition, and the like). The availability of such information, in accordance with some embodiments, enables the system 100 to match the particular notifications, alerts and reformatted presentation of message contents to the capabilities of the particular device a message author and/or recipient happens to be using.

Message manager module 140 further includes a tag identifier 180, which includes both a message envelope analyzer 182 and a message content analyzer 184. According to some embodiments, message envelope analyzer 182 determines the network address(s) of the recipient(s) specified by a received message, while message content analyzer 184 looks for one or more tags and, optionally, information specifically formatted and applicable to the tag. For example, to invoke a menu interface at a recipient's terminal, a message author might employ a specific tag followed by a specific expression as, for example, “@menu (option 1, option 2, option n)” and the like. The network address becomes useful where a tag relates to a specific user who happens to be one of many recipients to whom a message is addressed or intended.

By way of example, if a message were addressed to a group of recipients which includes “david.pike@vonage.com”, and the message were to include the tag @dave, reference to the message envelope enables message management agent 160 to select and send a special notification only to the communication terminal of David Pike. In other embodiments, the envelope analyzer 182 is omitted and the communication terminal is configured to recognize and process a tag specifically applicable to the user of at terminal. In either case, the inclusion of a tag applicable to a specific user enables a communication terminal to generate, for those messages designated by the tag, an alert which can be distinguished from those messages not designated by the tag. Thus, for example, a message deemed by a sender or message poster to be highly relevant to a particular recipient can be tagged in such a way as to call the recipient's attention to that fact.

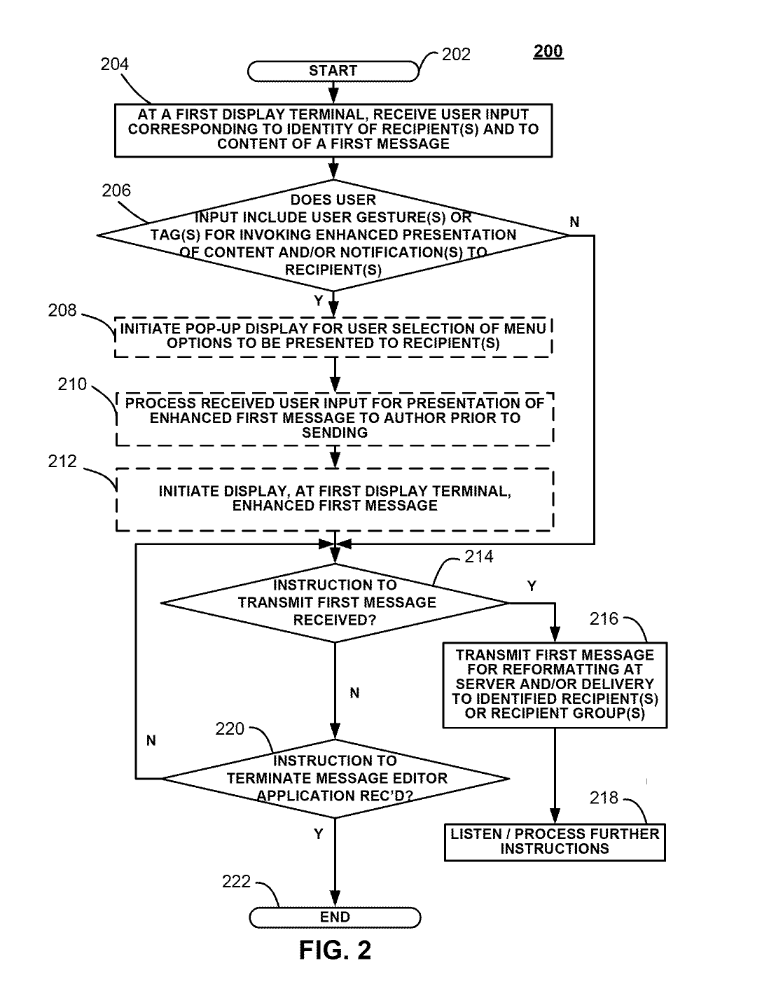

FIG. 2 is a flow diagram of a method 200 for managing the creation of tagged message content, at a first user communication terminal, to facilitate enhanced presentation of the message content and/or an accompanying notification, according to one or more embodiments of the invention. The method 200 starts at 202, and generally proceeds to 204.

At 204, method 200 receives user input corresponding to the content of a message and/or to the identity of one or more recipients. If present, an identity may specify a particular intended recipient by username or “handle”, or plurality of such intended participants, or an identifier which corresponds to members of a group who have “subscribed” or joined together to exchange messages on one or topics of collective interest. In embodiments, a message author provides the user input by invoking a graphic user interface (GUI) of a communication terminal. Typically, the GUI comprises a message editing window presented via the display, and it may further include a menu displayed for the purposes of identifying and/or selecting the network address and/or username/handle of the intended recipients or group for which the message is intended. Other information rendered to the display as part of the menu may, for example, comprise the name of the intended recipient(s) or group(s), a list of phone numbers, SIP addresses, and/or e-mail addresses stored in a local memory of the communication terminal and applicable to the intended recipient. In such embodiments, method 200 may be implemented entirely by a mobile terminal such, for example, as a smartphone, personal digital assistant (PDA), tablet, laptop computer, or the like. In other embodiments, some or all of the information accessed for display of the menu may be stored at a server, wherein the menu invoked by the GUI constitutes part of a communication client application as, for example, an application configured to initiate message exchanges, as well as telephone conversations, handled by a remote server.

The method 200 proceeds to 206, where method 200 determines whether the received user input includes user gesture(s) or tag(s) for invoking enhanced presentation of content and/or notifications to intended viewers (recipients) of the message. In some embodiments, a special character or symbol such as “@”or “%” is used to identify adjacent alphanumeric text as a tag. Thus for example, an entry of “@map” might correspond to a tag for invoking, at a recipient's communication terminal, the display of a map of a particular neighborhood or street. In addition to the tag itself, context to which the tag applies may be expressed as an appended parenthetical. For example, applying the @map example, the entry “@map ([street][city][state])” within a message would invoke, when processed at the communication terminal of a recipient, a map of the appended address.

In some embodiments, the message author enters a tag and corresponding context/label via a keypad, touchscreen or via speech-to-text input. In such cases, the message, once complete, may be forwarded immediately to the intended recipients. This may be via a peer-to-peer connection or via a communication network such, for example, as the internet, via one or more servers. In other embodiments, and as depicted in FIG. 2, method 200 determines that the user input received includes the tag and operates the communication terminal GUI so as to present one or both of an optional enhanced message editor associated with the tagged content (block 208) and an optional tagged message preview mode (blocks 210 and 212).

In 208, the presence of a tag within a message being drafted causes method 200 to initiate the presentation of a pop-up display. In an embodiment, the pop up display corresponds to a selection of options for the message author to navigate while constructing a message. By way of illustration, a message author who desires to present intended recipients with a choice of four restaurants for dinner might type “@menu” while entering message content into a default window editor. This would cause method 200 to initiate, according to one embodiment, display of a pop up menu asking the message author to enter each option (e.g., restaurant choice) as part of an interactive message creation process. In embodiments where the presentation of the pop-up display in 208 is omitted, the message author could alternatively enable the same processing by a recipient's terminal simply by typing the appended context manually as, for example, by typing “@menu (restaurant option 1, restaurant option 2, restaurant option 3, etc.).” In some embodiments, a message author may be prompted to choose between the interactive message creation mode described above and a manual mode, or even to disable the interactive mode.

From 208, the method 200 proceeds to 210, where method 200 processes the input received at 204 and/or 208 so as to generate a re-formatted or “enhanced” version of the message content so that the author can preview how the message will be seen by the recipient(s). Once generated, the method 200 proceeds to 212, where method 200 initiates display of the enhanced message to the display of the communication terminal being used by the message author. In some embodiments, the message author may be prompted to confirm whether or not to utilize the preview mode, the preview mode capability may be omitted altogether, or it may be selectively enabled or disabled as a user preference.

If method 200 determines at 206 that the message created does not include tags for interactive message generation or preview processing according to 208, 210, and 212, or that the user has elected to disable or bypass such functionality, method 200 proceeds directly to 214. Otherwise, method 200 performs the operations of 208, 210 and 212 before proceeding to 214. At 214, method 200 determines whether the message author has entered input confirming that the message is ready to be transmitted to one or more intended recipients. If so, the method 200 proceeds to 216 and transmits the tagged message for re-formatting at a server, according to some embodiments, or at the communication terminals of one or more recipients to whom the message is delivered, according to other embodiments.

From 216, method 200 proceeds to 218, where it listens for further instructions and/or input to be processed. If, at 214, method 200 does not determine that the message is to be transmitted, method 200 proceeds to 220, where the method 200 determines whether an instruction to terminate the message creation process without sending the message has been received. If so, the method 200 proceeds to 222 and terminate. If no such instruction is received after n seconds (where n is an integer greater than 1), the method 200 returns to 214 to again determine whether an instruction to send the message has been received. After performing the cycle of 214 and 220 m times (where m is a positive integer greater than 2), the method 200 proceeds to 222 and terminates.

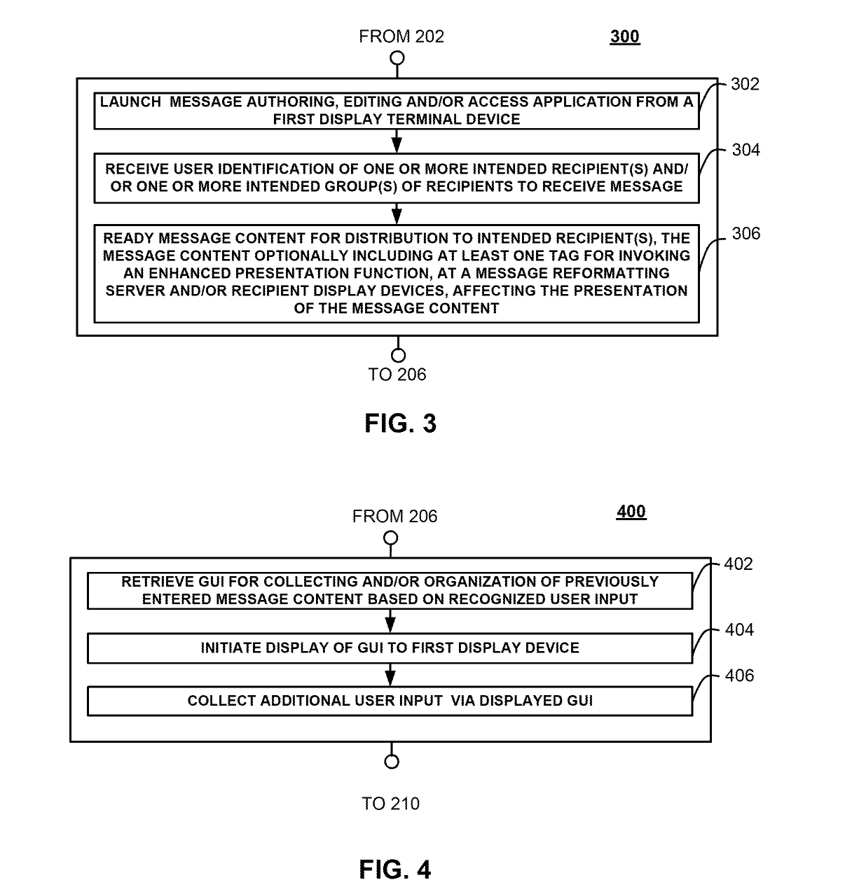

FIG. 3 is a flow diagram of a method 300 for creating messages having one or more embedded tags to facilitate the enhanced processing of the messages by a recipient communication terminal, as, for example, a sub-process of the method 200 of FIG. 2, according to one or more embodiments of the invention. In some embodiments, the method 300 is entered at 302, where method 300 launches, by execution of instructions by a processor of a communication terminal such as a first display terminal and/or of a server, a message authoring, editing, and/or access application. From 302, method 300 proceeds to 304, where method 300 receives user input corresponding to the identification of one or more intended recipients (as identified, for example, by a distinctive user name or “handle”, or a group handle corresponding to a list of such distinctive user names or handles).

From 304, the method 300 proceeds to 306, where method 300 readies the message content entered by the message author for distribution to the intended recipient(s). The message content optionally includes at least one or more tags for invoking an enhanced presentation function. The enhanced presentation function may be invoked at a message reformatting server and/or at the communication terminals of the intended recipient(s). According to one or more embodiments, the enhanced presentation function facilitated by the tag(s) affects the manner in which the content of messages and/or the notifications of their arrival and/or relevance are perceived by the intended recipients. For example, the enhanced presentation function may affect the way the content of a message is presented to a recipient (e.g., displayed on the display of a smart phone or desktop computer vs. audibly presented via an audio output device), the way the message content is arranged on a display (e.g., alphanumeric text vs. displayed image or menu with enhanced user interface), and/or the way a notification or alert applicable to a tagged message visually appears and/or is audibly reproduced as compared to an untagged message.

FIG. 4 is a flow diagram of a method 400 for creating messages, having one or more embedded tags to facilitate the enhanced processing of the messages by a recipient communication terminal, as, for example, a sub-process of the method 200 of FIG. 2, according to one or more embodiments of the invention. In some embodiments, the method 400 is entered at 402, where method 400 retrieves, by execution of instructions of a processor of a communication terminal such as a first display terminal and/or by the processor of a server, a set of rules and options for a graphical user interface (GUI) configured to operate the communication terminal to collect additional user input than what was provided at 204 of method 200 (FIG. 2) and/or to organize the input which was previously entered and received at 204.

From 402, the method 400 proceeds to 404, where the method 400 initiates the display of the retrieved GUI to a first display device (i.e., the communication terminal used by a message author). From 404, the method 400 proceeds to 406. At 406, method 400 collects additional user input via the displayed GUI. By way of illustrative example, responsive to entry of the tag “@menu” via his or her communication terminal, method 400 might at 404 retrieve a GUI for collecting user input specifically relating to the generation of a menu comprising a plurality of options to be presented to intended recipients of the message.

In an embodiment, the method 400 updates the GUI at 404 so as to prompt the message author to enter alphanumeric text or speech input corresponding to a query to be presented to the intended recipient(s). Example replies to this prompt at 406 might include: “Where do you want to eat tonight?” or “Which movie do you want to see tonight”? Following collection of the user input response to the query at 406, method 400 updates the GUI at 404, this time prompting the message author to provide input corresponding to a first choice to be presented to the recipient(s) in the form of a menu template identified by the @menu tag. To this prompt, the user might respond by identifying the name of a first restaurant or movie choice. After collecting the input corresponding to the choice at 406, method 400 prompts the message author to confirm whether he or she has further options to include and, if so, to repeat the aforementioned collection step 406 until all requisite user input has been provided.

By way of alternative example, method 400 might respond to user input corresponding to both the tag @menu, as exemplified above, and the tag @time. Here, method 400 might select a modified template which, as before, prompts the message author to identify a query to be presented to the intended recipient(s). However, rather than initiate the display of a sequence of prompts wherein the author is required to enter specific menu choices in seriatim, the method 400 interprets the combination of @menu and @time as an indication that the menu choices are to correspond to particular times of day such that the only pertinent parameters are the starting time of a range, the ending time of a range, and the increments of time between each menu choice. Thus, for example, after collecting at 406 inputs from the author specifying the query “What time would you like to meet for lunch”, method 400 might update the GUI to present a series of drop down menus for specifying the time range and to select between increments measured by minute, quarter hour, or half hour.

Once sufficient input is collected from the message author to append the appropriate context to each tag, a version of the message ready for transmission or forwarding to the recipient(s) is readied for transmission. It will thus be appreciated that a user may either manually prepare an entire message complete with both the tags and context, or he or she may simply enter the tags and then follow an interactive process for entering additional input so that an appropriately formatted message, matching each tag with its appropriate context, is generated automatically.

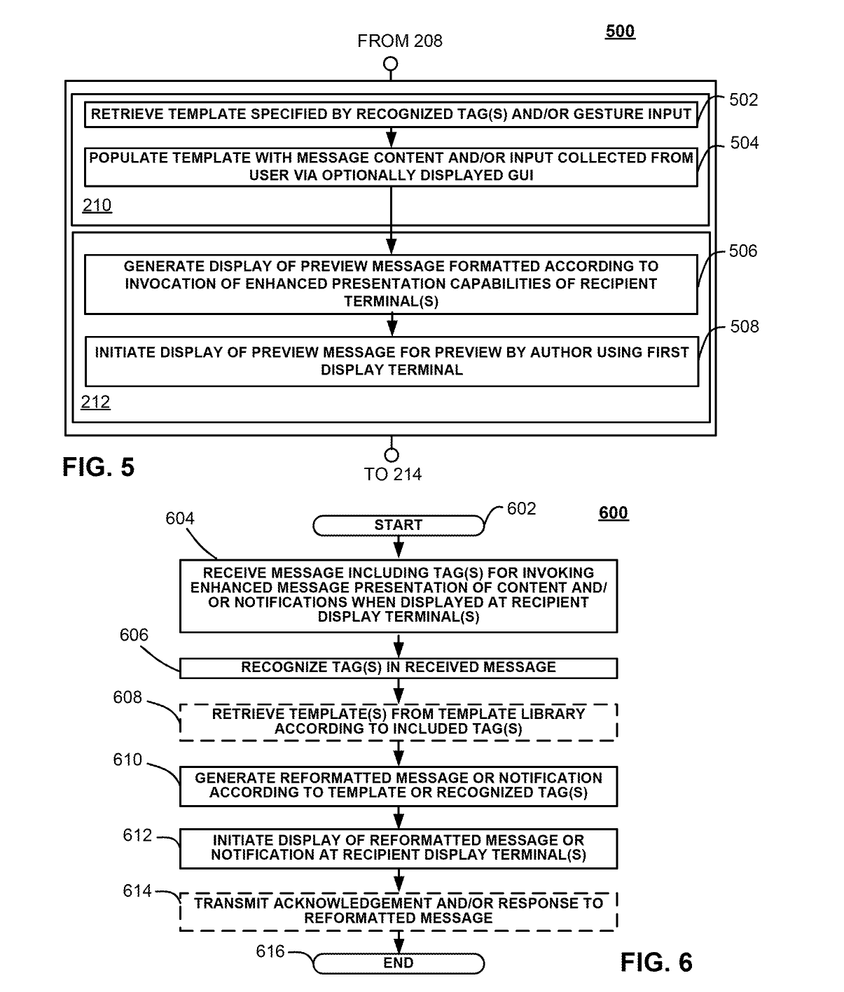

FIG. 5 is a flow diagram of a method 500 for previewing messages having one or more embedded tags, during a message creating process, to facilitate the enhanced processing of the messages by a recipient communication terminal, as, for example, a sub-process of the method 200 of FIG. 2, according to one or more embodiments. The method 500 is entered at 502, where method 500 selects and retrieves a template based, for example, on method 200 recognizing one or more tag(s) or gestures from user input (FIG. 2). From 502, the method 500 proceeds to 504 where method 500 populates the retrieved template with message content entered by and/or collected from the message author.

From 504, the method 500 proceeds to 506, where method 500 generates, for display, a re-formatted version of the entered/collected message content. The formatting applied to the message content by method 500 facilitates the invocation of enhanced presentation capabilities by or at the communication terminal(s) of one or more recipients (i.e. according to an enhanced presentation mode of operation), as well as by the communication terminal of the message author (according to a preview mode of operation). From 506, method 500 proceeds to 508, where method 500 initiates display of the re-formatted message for preview at the communication terminal of the message author. In embodiments where different modes of presenting the message content to some of the intended recipients are supported or applicable (as method 500 may determine by reference to centrally stored recipient device profiles and/or account settings), the message author may optionally elect to preview the message content in any or all of the applicable modes of enhanced presentation supported by his or her own device. Once the user has previewed and is satisfied with the substance and appearance of the re-formatted message content, the message is forwarded for delivery to the communication terminals of the intended recipients. Once delivered, a message containing tags and content is processed to provide an enhanced user experience to the intended recipients.

FIG. 6 is a flow diagram of a method 600 for processing and/or presenting received messages, having one or more embedded tags, to facilitate the enhanced processing of the messages by a recipient communication terminal, according to one or more embodiments of the invention. The method 600 is entered at 602 and proceeds to 604.

At 604, method 600 receives a first message which includes one or more tags, as well as the applicable context needed for invoking the enhanced presentation functionality corresponding to the tag(s). The enhanced presentation functionality, as mentioned earlier, controls the manner in which message content and/or notifications or alerts relating to the message are perceived by the recipient using a communication terminal. If the recipient's communication terminal does not support the process of recognizing tags and re-formatting the messages based on the tags, a recipient is unable to experience the enhanced presentation functionality but can nonetheless interpret the meaning of the message content as he or she would interpret any standard SMS or IM Chat message.

From 604, the method 600 proceeds to 606, where method 600 recognizes any included tags and associated context. At 608, the method 600 retrieves one or more templates from a template library according to the recognized tag(s). From 608, method 600 proceeds to 610 where method 600 generates a re-formatted message and/or notification according to the retrieved template, the context appended to the tag, and to any other message content present in the message. From 610, the method 600 proceeds to 612, where the method 600 initiates presentation (e.g., display) of the re-formatted notification and/or message via the recipient's communication terminal. In some embodiments, for example, a tag may specify that a particular message is of particular relevance to a communication terminal user. For a message which includes the tag @Bob311, method 600 might cause the receiving communication terminal used by that intended recipient to generate a special audio alert and/or to highlight that message in a different color so that when the message subject/header is displayed in a list of received messages, the recipient can quickly navigate to that message while deferring review of any received messages not so identified.

In some embodiments, method 600 proceeds from 612 to 614, where method 600 transmits an acknowledgement and/or response to the reformatted message. In some embodiments, for example, a re-formatted message comprises a menu/GUI generated at the recipient's communication terminal using tags and associated context. Such a re-formatted message might enable the recipient to respond to a query with minimal input. For example, depending on the device profile for the terminal and the account settings associated with the recipient, the user might simply enter touch screen input to choose a radio button for one menu option from among a list of menu options followed by depressing a soft “send” key. Alternatively, the user might be prompted to speak “A” “B” or “C” to choose from among three options so identified, and to say “send” after doing so. It suffices to say that enhanced presentation capabilities consistent with the present disclosure admit of substantial variation and great flexibility. Following 612 or, if applicable, 614, the method 600 is terminated at 616.

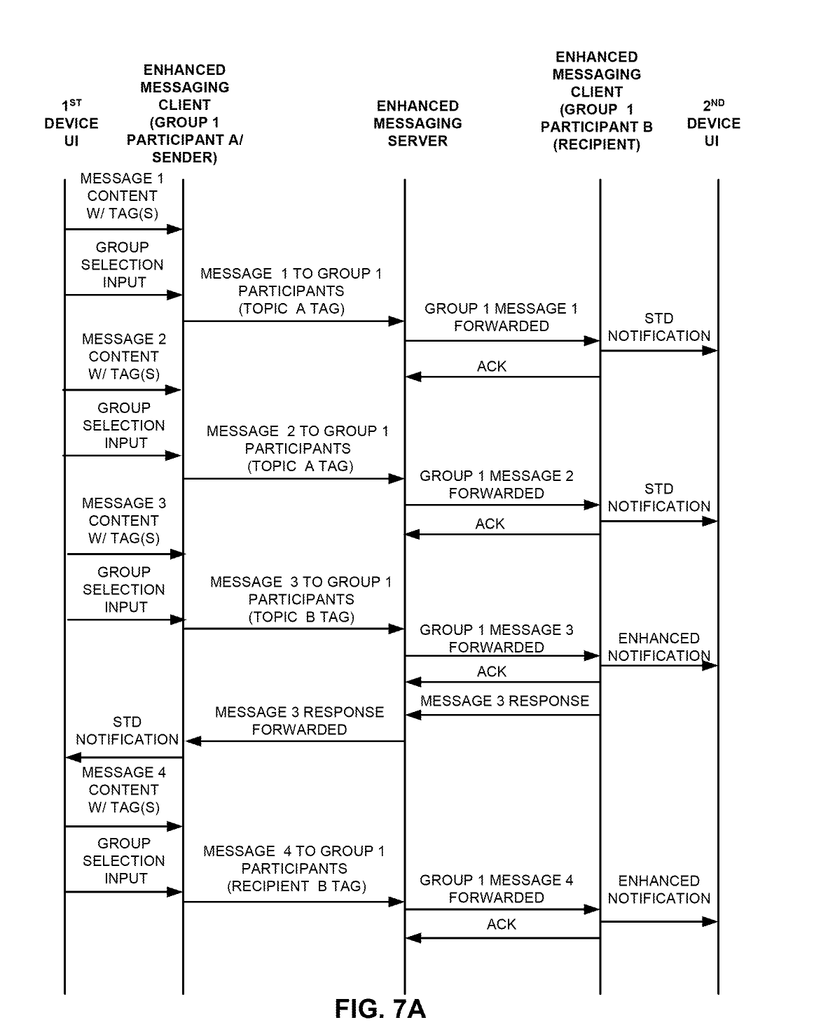

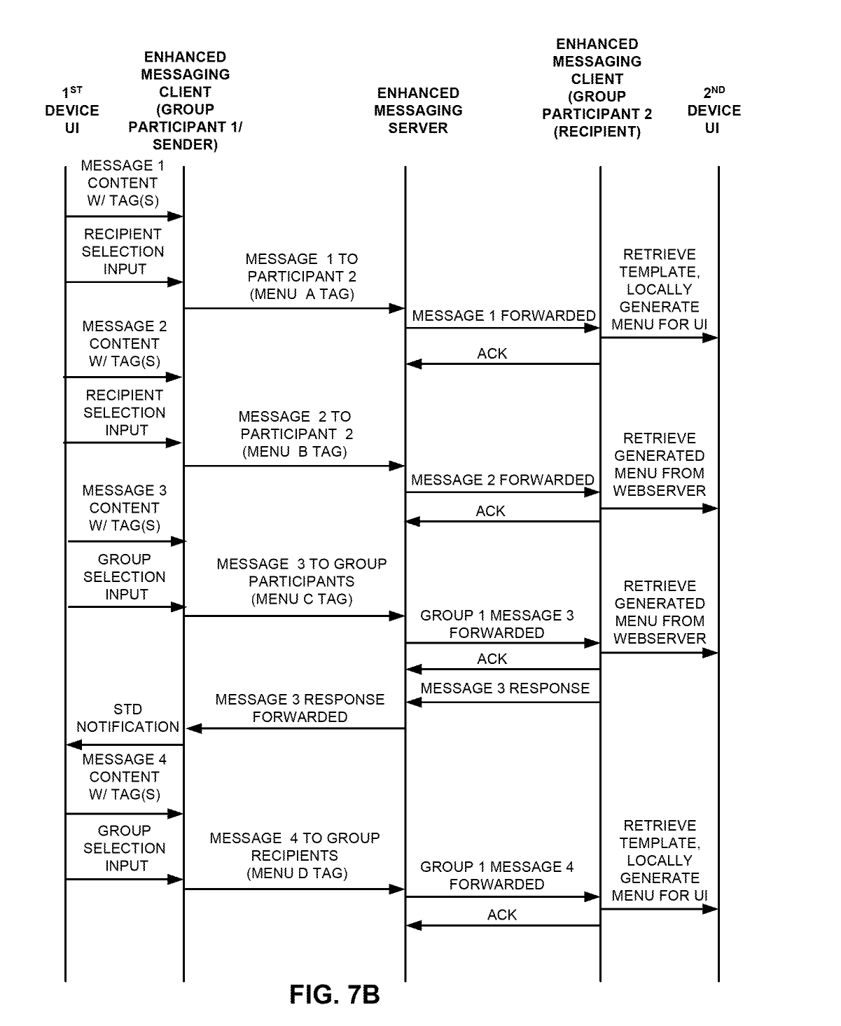

FIG. 7A is a message flow diagram depicting the development, flow and processing of messages between a first message exchange participant (e.g., a sender) and a second message exchange participant (e.g., a recipient), at least some of the messages including tags for enhancing the presentation of notifications to a message recipient in accordance with one or more embodiments. In embodiments exemplified by FIG. 7A, a series of messages originate at a first communication terminal device on which an enhanced messaging client is executed by a processor. The messages are intended to be accessed and reviewed by a group of users (“Group 1”) which includes the user of a second communication terminal device on which an enhanced messaging client is executed by a processor. The first two messages (“Message 1” and “Message 2”) in the series include the “Topic A” while a third message (“Message 3”) includes the “Topic B” tag (e.g. “@TopicA” and “@TopicB”, respectively). Finally, a fourth message (“Message 4”) includes a tag which identifies one of the participants in Group 1 by his or her username (“Participant B”) which corresponds to the user of second communication terminal.

In the example of FIG. 7A, the user of the second communication terminal has identified (as by subscription or user profile data) Topic B as being of particular interest but not Topic A. As such, the enhanced messaging client executing on the second communication terminal processes the received Messages 1 and 2 so as to send a “standard notification” to Participant B. A standard notification may, for example, include a short audible tone and/or an update of the display to show arrival of a new message with no further information, used by default by the enhanced messaging client in the absence of a tag. On the other hand, because the Message 3 contains a tag of particular relevance to Participant B, the enhanced messaging client processes the tagged Message 3 differently than the preceding two messages. Thus, for example, a unique audible tone applicable to Topic B and/or to all “higher priority” topics may be generated by the communication terminal used by Participant B. In addition, or alternatively, Message 3 may appear in the same list of new messages as Messages 1 and 2, but it may be rendered to the display of the second communication terminal such that it is readily distinguishable (i.e., by a different text color or highlighting).

With continued reference to FIG. 7A, it will be recalled that the Message 4″ is intended for distribution to all members of Group 1 but includes a tag which specifically identifies Participant B. Thus, at the second communication terminal (which is operated by Participant B), the enhanced messaging client forwards an enhanced notification to the user interface of the second communication terminal. As in the case of Message 3, this enhanced message may include an audible tone distinguishable from the default or standard notification and/or distinctly colored or highlighted text rendered to the user's display.

Where FIG. 7A exemplifies the flow of messages including tags to facilitate enhanced notifications, FIG. 7B is a message flow diagram depicting the development, flow and processing of messages between a first message exchange participant (e.g., a sender) and a second message exchange participant (e.g., a recipient), at least some of the messages including tags for enhancing the presentation of message content a message recipient in accordance with one or more embodiments.

In embodiments exemplified by FIG. 7B, a series of messages originate at a first communication terminal device (of a sender) on which an enhanced messaging client is executed by a processor. The messages are intended to be accessed and reviewed by Participant 2, or to a group of users (“Group 1”) with which Participant 2 is associated. Participant 2 operates a second communication terminal device on which an enhanced messaging client is executed by a processor.

The first two messages (“Message 1” and “Message 2”) in the series are directed only at Participant 2 and include the tag “@MenuA” and “@MenuB”, respectively. The third and fourth message (“Message 3” and “Message 4”) are directed to all participants of Group 1 and include the tag “@MenuC” and “@MenuD” respectively.

Since Participant 2 is the user of the second communication terminal identified in FIG. 7B and is specifically identified as the sole addressee of Message 1, the second communication terminal retrieves a menu template and via the user interface of the terminal, a menu is presented to Participant 2. The menu includes the context specified by the appended character “A” and/or any other associated context and message content included in the message. If the UI is configured to collect a response from Participant 2, input provided by Participant 2 via the second communication terminal is received and used to generate a message formatted to supply a complete response (e.g., for processing by the communication terminal of the query originator).

In each of Messages 2 through 4 of FIG. 7B, a respective menu is retrieved and presented to Participant 2 via the second communication terminal. Like Message 1, Message 4 is generated by retrieving a template from local storage at the second communication terminal. Such operation may be better adapted to communication terminals having substantial memory storage capacity such, for example, as desktop, laptop or notebook computers. Messages 2 and 3, on the other hand, rely upon a central server such, for example, as a web server, to supply the template and, in some cases, to generate the finished menu/UI for presentation to Participant 2 via the second communication terminal.

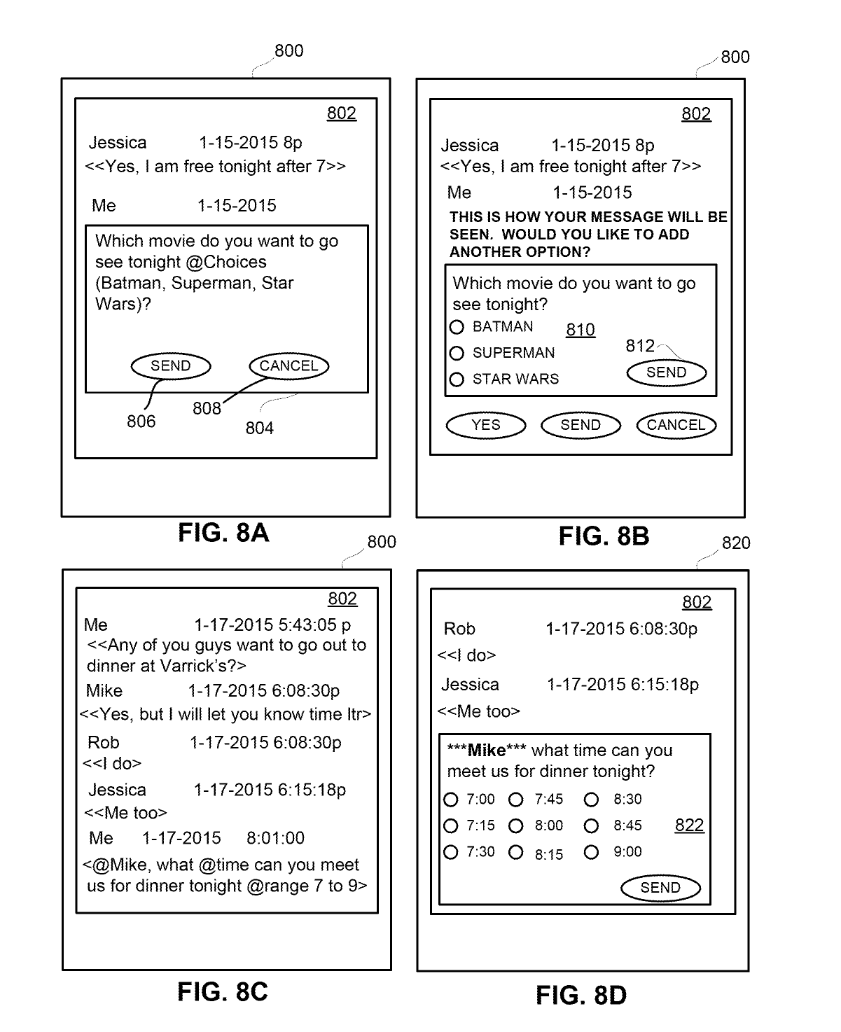

FIG. 8A depicts a communication terminal 800 operated by a user to visually present a sequence of messages forming at least part of a first message exchange between two or more participants and to create, edit or forward a message containing one or more tags for enhancing the experience of the recipient(s), according to one or more embodiments of the invention. The sequence of messages are rendered to a display 802, which also provides a text editor window 804 for the user of communication terminal 800 to enter a query followed by the tag @choices and, in parentheses, a list of options. In this embodiment, an interactive mode for generating the tagged message may be bypassed but a mode for previewing the entered content and tags is contemplated. As such, the user enters one or more tags, context and content in the editor window and is presented with a “send” feature button 806 and a “cancel” feature button 808. By electing to send the message, as by touch screen or mouse click input, the “tagged” message shown in the window 804 is rendered to display 802, as shown in FIG. 8B

FIG. 8B depicts the communication terminal 800 of FIG. 8A following the processing of received message content and corresponding tag(s) to generate a reformatted presentation of the message content for preview based on a single included tag, according to one or more embodiments of the invention. Here, each of the comma delineated choices which were entered within the parentheses (FIG. 8A) are arranged in a preview window 810 next to a corresponding radio button, complete with a “send” button 812 which will be used as part of the user interface generated at the recipient's communication terminal. The user of terminal 800 is asked whether he or she would like to add further options (the default being to bypass the interactive editor mode). If not, the message feature buttons for sending the message as formatted in the window 804 of FIG. 8A or canceling that action are again displayed on display 802. If so, a “yes” soft button or mouse clickable option is also displayed to enter an interactive editing mode according, for example, to method 400 (FIG. 4).

FIG. 8C depicts the communication terminal 800 of FIGS. 8A and 8B operated by a user to visually present on display 802 a sequence of messages forming at least part of a second message exchange between two or more participants and to create, edit or forward a message containing a plurality of tags for enhancing the user experience of a recipient, according to one or more embodiments of the invention. Here both the interactive message creation and preview modes are bypassed, and the message includes a tag identifying a particular recipient (i.e., “@Mike”) and two additional tags (“@time” and “@range”).

FIG. 8D depicts a recipient communication terminal 820 participating in the exchange presented on the display shown in FIG. 8C and following the processing of received message content and corresponding tags to generate a reformatted presentation of the message content based on a plurality of included tags, according to one or more embodiments of the invention. Specifically, the message shown on display 802 of communication terminal 800 is received at recipient communication terminal 820 and processed, by execution of instructions stored in memory of terminal 820, so as to produce the re-formatted message shown within the window 822. In this case, the @time tag utilizes a default increment of 15 minutes, and the tag @range in conjunction with @time is automatically understood to correspond to the boundaries of a time window used to generate the UI displayed within window 822.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, embodiments of the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of embodiments of the present invention may be written in an object oriented programming language, such as Java.®, Smalltalk or C++, and the like. However, the computer program code for carrying out operations of embodiments of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit embodiments of the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

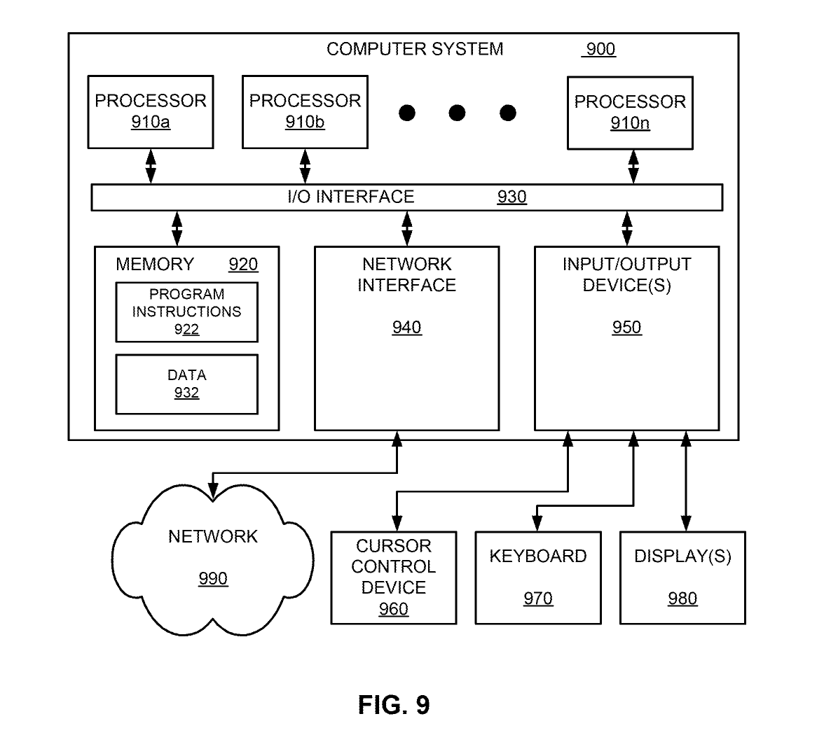

FIG. 9 is a detailed block diagram of a computer system, according to one or more embodiments, that can be utilized in various embodiments of the present invention to implement the computer and/or the display devices, according to one or more embodiments.

Various embodiments of method and apparatus for organizing, enhancing and presenting message content and associated notifications, as described herein, may be executed on one or more computer systems, which may interact with various other devices. One such computer system is computer system 900 illustrated by FIG. 9, which may in various embodiments implement any of the elements or functionality illustrated in FIGS. 1-8D. In various embodiments, computer system 900 may be configured to implement methods described above. The computer system 900 may be used to implement any other system, device, element, functionality or method of the above-described embodiments. In the illustrated embodiments, computer system 900 may be configured to implement method 200 (FIG. 2), method 300 (FIG. 3), method 400 (FIG. 4), method 500 (FIG. 5), method 600 (FIG. 6), method 700 (FIG. 7A) and/or method 710 (FIG. 7B) as processor-executable executable program instructions 922 (e.g., program instructions executable by processor(s) 910) in various embodiments.

In the illustrated embodiment, computer system 900 includes one or more processors 910a-910n coupled to a system memory 920 via an input/output (I/O) interface 930. Computer system 900 further includes a network interface 940 coupled to I/O interface 930, and one or more input/output devices 750, such as cursor control device 960, keyboard 970, and display(s) 980. In various embodiments, any of the components may be utilized by the system to receive user input described above. In various embodiments, a user interface may be generated and displayed on display 980. In some cases, it is contemplated that embodiments may be implemented using a single instance of computer system 900, while in other embodiments multiple such systems, or multiple nodes making up computer system 900, may be configured to host different portions or instances of various embodiments. For example, in one embodiment some elements may be implemented via one or more nodes of computer system 900 that are distinct from those nodes implementing other elements. In another example, multiple nodes may implement computer system 900 in a distributed manner.

In different embodiments, computer system 900 may be any of various types of devices, including, but not limited to, a personal computer system, desktop computer, laptop, notebook, or netbook computer, mainframe computer system, handheld computer, workstation, network computer, a set top box, a mobile device such as a smartphone or PDA, a consumer device, video game console, handheld video game device, application server, storage device, a peripheral device such as a switch, modem, router, or in general any type of computing or electronic device.

In various embodiments, computer system 900 may be a uniprocessor system including one processor 910, or a multiprocessor system including several processors 910 (e.g., two, four, eight, or another suitable number). Processors 910 may be any suitable processor capable of executing instructions. For example, in various embodiments processors 910 may be general-purpose or embedded processors implementing any of a variety of instruction set architectures (ISAs). In multiprocessor systems, each of processors 910 may commonly, but not necessarily, implement the same ISA.

System memory 920 may be configured to store program instructions 922 and/or data 932 accessible by processor 910. In various embodiments, system memory 920 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 920. In other embodiments, program instructions and/or data may be received, sent or stored upon different types of computer-accessible media or on similar media separate from system memory 920 or computer system 900.

In one embodiment, I/O interface 930 may be configured to coordinate I/O traffic between processor 910, system memory 920, and any peripheral devices in the device, including network interface 940 or other peripheral interfaces, such as input/output devices 950. In some embodiments, I/O interface 930 may perform any necessary protocol, timing or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. Also, in some embodiments some or all of the functionality of I/O interface 930, such as an interface to system memory 920, may be incorporated directly into processor 910.

Network interface 940 may be configured to allow data to be exchanged between computer system 900 and other devices attached to a network (e.g., network 990), such as one or more display devices (not shown), or one or more external systems or between nodes of computer system 900. In various embodiments, network 990 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 940 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 950 may, in some embodiments, include one or more communication terminals, keyboards, keypads, touchpads, scanning devices, voice or optical recognition devices, or any other devices suitable for entering or accessing data by one or more computer systems 900. Multiple input/output devices 950 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 940.

In some embodiments, the illustrated computer system may implement any of the methods described above, such as the methods illustrated by the flowcharts of FIGS. 2-6. In other embodiments, different elements and data may be included.

Those skilled in the art will appreciate that computer system 900 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 900 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer implemented method, comprising:
receiving a message including an identification of one or more recipients and message content;
determining, by execution of instructions by a processor, that the received message includes a tag for invoking at least one of enhanced presentation of the message content or a notification; and
generating at least one of
a reformatted message, wherein the reformatted message includes the message content reorganized according to the tag, or
a notification, formatted according to the tag, for alerting at least one of the one or more recipient that the message relates to a particular topic or has an enhanced priority.

2. The method of claim 1, wherein the received message includes at least one tag identifying a specific topic of interest.

3. The method of claim 1, wherein the received message includes at least one tag identifying a specific recipient.

4. The method of claim 1, wherein the received message is one of a short-message-service (SMS) text message, an instant message (IM) chat message, or a multimedia-messaging-service (MMS) message.

5. The method of claim 1, wherein the received message includes at least one tag specifying a template for presenting menu choices.

6. The method of claim 5, further including retrieving the specified template from a template library.

7. The method of claim 6, wherein a reformatted message is generated at a server, the method further including transmitting the reformatted message to one or more recipient communication terminals.

8. The method of claim 6, wherein a reformatted message is generated at a recipient communication terminal, the method further including initiating display of the reformatted message at the one or more recipient communication terminals.

9. A computer implemented method, comprising:
at a first communication terminal, receiving user input corresponding to an identification of one or more recipients and to message content;
initiating display of the message content according to a user interface;
determining, by execution of instructions by a processor of the first communication terminal, that the received user input includes a tag for invoking at least one of enhanced presentation of the message content or a notification;
generating at least one of
a preview message, wherein the message content is formatted for presentation according to the tag, or
a preview notification, wherein the preview notification is formatted according to the tag to alert at least one of the one or more recipients that the message relates to a particular topic or has an enhanced priority; and
initiating display of at least one of the preview message or preview notification at the first communication terminal.

10. The method of claim 9, further including transmitting, from the first communication terminal, a message addressed to the one or more recipients and including received message content and at least one tag.

11. The method of claim 9, wherein the determining step includes determining whether the detected at least one tag identifies a topic of potential interest to an identified group of recipients.

12. The method of claim 9, wherein the determining step includes determining whether the detected at least one tag identifies a specific recipient among a group of recipients identified by the received message.

13. The method of claim 9, wherein at least one tag included in the received user input specifies a template for presenting choices to the one or more recipients.

14. The method of claim 13, further including retrieving the specified template from a template library.

15. The method of claim 9, further including initiating display of a user interface, responsive to input invoking a tag function received at the first communication terminal, for prompting the user to enter additional message content; and
transmitting a reformatted message including the additional message content and at least one tag assigned to the additional message content, for delivery to a recipient.

16. A system for managing presentation of enhanced message content at a recipient user communication terminal, comprising:
a display;
a processor; and
a memory containing instructions executable by the processor
to receive a message including an identification of one or more recipients and message content;
to determine, by execution of instructions by the processor, that the received message includes a tag for invoking at least one of enhanced presentation of the message content or a notification; and
to generate at least one of
a reformatted message, wherein the reformatted message includes the message content reorganized according to the tag, or
a notification, formatted according to the tag, for alerting at least one of the one or more recipient that the message relates to a particular topic or has an enhanced priority.

17. The system of claim 16, wherein the memory further contains instructions executable by the processor to initiate display of the reformatted message but not the received message.

18. The system of claim 16, wherein the memory further contains instructions executable by the processor to initiate display of the formatted notification such that it is distinguishable from other messages received from a common message author or a group of message authors.

19. The system of claim 16, wherein the memory further contains instructions executable by the processor to initiate display of the formatted notification with at least one of a subject and topic identifier such that it is distinguishable from other messages identified by a different topic or received from a common message author or a group of message authors.

20. A system for managing presentation of enhanced message content at a recipient user communication terminal, comprising
means for receiving a message including an identification of one or more recipients and message content;
means for determining, by execution of instructions by a processor, that the received message includes a tag for invoking at least one of enhanced presentation of the message content or a notification; and
means for generating, responsive to a determination that the received message includes a tag, at least one of
a reformatted message, wherein the reformatted message includes the message content reorganized according to the tag, or
a notification, formatted according to the tag, for alerting at least one of the one or more recipient that the message relates to a particular topic or has an enhanced priority.
